(19) United States
(12) Patent Application Publication
(10) Pub. No.: US 2006/0206316 A1
(43) Pub. Date: Sep. 14, 2006

(54) Audio coding and decoding apparatuses and methods, and recording mediums storing the methods

(75) Inventors: Hosang Sung, Yongin-si (KR); Rakesh Taori, Suwon-si (KR); Kangeun Lee, Gangneung-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO. LTD., Suwon-si (KR)

(21) Appl. No.: 11/333,342

(22) Filed: Jan. 18, 2006

(30) Foreign Application Priority Data
Mar. 10, 2005 (KR) 10-2005-0020136

(51) Int. Cl. G10L 11/04

(52) U.S. Cl. 704/207

(57) ABSTRACT

Audio coding and decoding apparatuses and methods that can optimize the quality of an audio signal including harmonics, and recording mediums storing the methods. An audio coding apparatus includes: a first harmonic coding module performing first harmonic coding on an input audio signal using a pitch lag of the input audio signal and producing a quantized linear prediction coding coefficient; a first detector detecting a first difference audio signal from a difference between an audio signal output from the first harmonic coding module and the input audio signal; a second harmonic coding module performing harmonic coding on the first difference audio signal using the quantized linear prediction coding coefficient and a previous harmonic coding result; a second detector detecting a second difference audio signal obtained from a difference between an audio signal output from the second harmonic coding module and the first difference audio signal; and a code excited linear prediction (CELP) module CELP coding the second difference audio signal using the quantized linear prediction coding coefficient obtained from the first harmonic coding module.

### CROSS-REFERENCE TO RELATED APPLICATION

This application claims the benefit of Korean Patent Application No. 10-2005-0020136, filed on Mar. 10, 2005, in the Korean Intellectual Property Office, the disclosure of which incorporated herein by reference.

### BACKGROUND OF THE INVENTION

1. Field of the Invention

The present invention relates to audio coding and decoding apparatuses and methods, and recording mediums on which the methods are recorded, and more particularly, to audio coding and decoding apparatuses and methods in which the quality of an audio signal including harmonics can be optimized, and recording mediums on which the methods are recorded.

2. Description of Related Art

As the range of applications of audio coders has increased, the demand for low transmission rate coders has also increased. As such, a code excited linear prediction (CELP) coder is being used for transmission rates equal to or greater than 4 kbps, and a harmonic-CELP coder is being used for transmission rates of less than 4 kbps. The reason why a harmonic-CELP coder is being used for transmission rates of less than 4 kbps is that, in a CELP coding algorithm, sound quality is lowered when there are too few quantization bits, whereas, in a harmonic coding algorithm, the periodicity of a voiced sound that greatly affects sound quality, even fewer smaller bits, is well modeled.

A harmonic vector excitation coder (HVXC), which uses the MPEG-4 audio standard is an example of a harmonic-CELP coder. An HVXC is characterized by quantization of a variable dimension harmonic vector, high-speed harmonic synthesis, harmonic amplitude estimation using a real number pitch, and natural property control using noise mixing.

However, in a harmonic-CELP coder, an audio signal section (or voiced sound section) including harmonics is formed by interpolating standard waveforms of a previous frame and a current frame so that there is a high probability that pitch halving prediction in which a pitch lag is reduced by half or pitch doubling prediction in which a pitch lag is doubled can be performed in a transition section of the harmonic-CELP coder. When the pitch halving prediction or the pitch doubling prediction is performed, waveform distortion and discontinuity occur at a frame boundary due to a severe amount of variation of pitch lag.

In addition, since an overlap-addition method through a triangular window is used in harmonic synthesis, when a signal in an audio signal section including harmonics in a transition section increases or decreases instantaneously, a synthesis excitation signal may disadvantageously increase or decrease linearly due to the effect of the triangular window.

### BRIEF SUMMARY

An aspect of the present invention provides audio coding and decoding apparatuses and methods in which the quality of an audio signal including harmonics can be optimized, and recording mediums on which the methods are recorded.

An aspect of the present invention also provides audio coding and decoding apparatuses and methods in which pitch halving prediction or pitch doubling prediction in an audio signal section including harmonics can be prevented, and recording mediums on which the methods are recorded.

An aspect of the present invention also provides audio coding and decoding apparatuses and methods in which harmonic amplitude information is converted into a quantized LPC coefficient and the quantized LPC coefficient is used to extract LPC coefficients needed by a second harmonic coding module and a CELP module, and recording mediums on which the methods are recorded.

An aspect of the present invention also provides audio coding and decoding apparatuses and methods in which bit allocation for a plurality of coding modules is performed differently according to whether harmonics are included in an input audio signal, and recording mediums on which the methods are recorded.

An aspect of the present invention also provides audio coding and decoding apparatuses and methods in which scalability can be easily applied, and recording mediums on which the methods are recorded.

According to an aspect of the present invention, there is provided an audio coding apparatus, the audio coding apparatus including: a first harmonic coding module performing first harmonic coding on an input audio signal using a pitch lag of the input audio signal and producing a quantized linear prediction coding coefficient; a first detector detecting a first difference audio signal from a difference between an audio signal output from the first harmonic coding module and the input audio signal; a second harmonic coding module performing harmonic coding on the first difference audio signal using the quantized linear prediction coding coefficient and a previous harmonic coding result; a second detector detecting a second difference audio signal obtained from a difference between an audio signal output from the second harmonic coding module and the first difference audio signal; and a code excited linear prediction (CELP) module CELP coding the second difference audio signal using the quantized linear prediction coding coefficient obtained from the first harmonic coding module.

The first harmonic coding module may convert an amplitude of harmonics of the input audio signal into a linear prediction coding coefficient, quantize the converted linear prediction coding coefficient, and provide the quantized linear prediction coding coefficient to the second harmonic coding module and the CELP module, respectively.

The second harmonic coding module may extract a quantized linear prediction coding coefficient needed for the second harmonic coding using the quantized linear prediction coding coefficient obtained from the first harmonic coding module.

According to another aspect of the present invention, there is provided an audio decoding apparatus, the audio decoding apparatus including: an inverse quantization unit inverse quantizing each of a plurality of parameters to restore an audio signal; a first harmonic decoding module performing harmonic decoding using a linear prediction coding coefficient and a phase vector output from the inverse quantization unit; a second harmonic decoding module performing harmonic decoding based on the linear prediction coding coefficient, a harmonic index, and a first gain value output from the inverse quantization unit; a first adder adding a signal output from the first harmonic decoding module to a signal output from the second harmonic decoding module; a code excited linear prediction (CELP) decoding module performing CELP decoding based on a stochastic codebook index output from the inverse quantization unit and a second gain value output from the inverse quantization unit; and a second adder adding a signal output from the first adder to a signal output from the CELP decoding module and outputting the result as a restored audio signal.

According to another aspect of the present invention, there is provided an audio coding method, the audio coding method including: harmonically coding an input audio signal without analyzing a linear prediction coding coefficient; analyzing a linear prediction coding coefficient of a difference audio signal obtained from a difference between the input audio signal and the harmonic-coding result and harmonically coding the difference audio signal; and CELP coding a difference audio signal obtained from a difference between the result of harmonically coding on the difference audio signal and the input audio signal.

According to another aspect of the present invention, there is provided an audio decoding method, the audio decoding method including: inverse quantizing a plurality of parameters for restoring an audio signal; first harmonic decoding using a linear prediction coding coefficient and a phase vector obtained through the inverse quantizing; second harmonic decoding using a linear prediction coding coefficient, a harmonic index, and a first gain value obtained through the inverse quantizing; first adding the first harmonic decoding result to the second harmonic decoding result; CELP decoding using a stochastic index and a second gain value obtained through the inverse quantization; and adding the result obtained through the first adding to the result obtained through the CELP decoding to obtain a restored audio signal.

According to another aspect of the present invention, there is provided a recording medium on which a program for performing an audio coding method is recorded, the audio coding method including: harmonically coding an input audio signal without analyzing a linear prediction coding coefficient; analyzing a linear prediction coding coefficient of a difference audio signal obtained from a difference between the input audio signal and the harmonic-coding result and harmonically coding the difference audio signal; and CELP coding a difference audio signal obtained from a difference between the result of harmonically coding on the difference audio signal and the input audio signal.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a functional block diagram of an audio coding apparatus according to an embodiment of the present invention;

FIG. 2 is a detailed block diagram of a first harmonic coding module shown in FIG. 1;

FIG. 3 is a detailed block diagram of a second harmonic coding module shown in FIG. 1;

FIG. 4 is a detailed block diagram of a CELP module shown in FIG. 1;

FIG. 5 is a functional block diagram of an audio decoding apparatus according to another embodiment of the present invention;

FIG. 6 is a flowchart illustrating an audio coding method according to another embodiment of the present invention; and

FIG. 7 is a flowchart illustrating an audio decoding method according to another embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

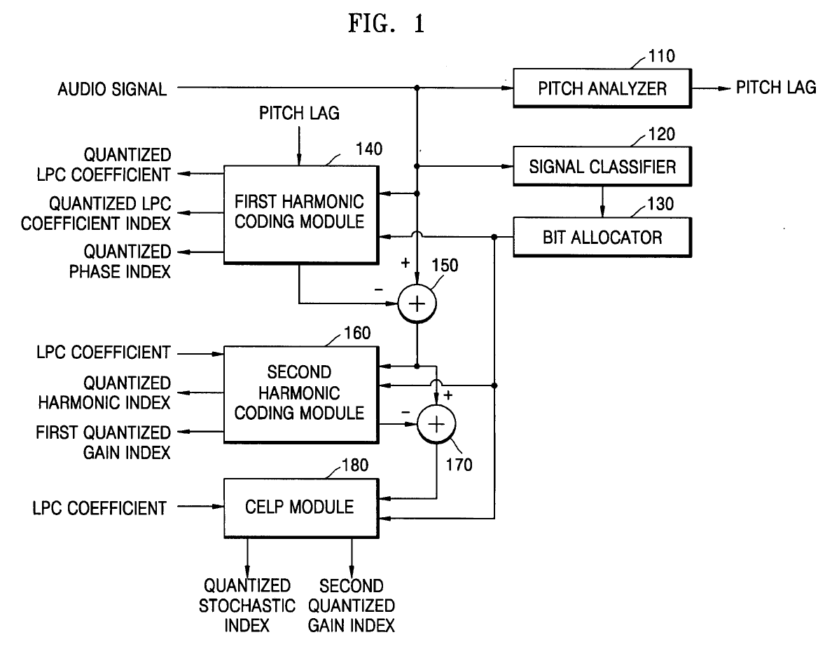

FIG. 1 is a functional block diagram of an audio coding apparatus according to an embodiment of the present invention. Referring to FIG. 1, the audio coding apparatus includes a pitch analyzer 110, a signal classifier 120, a bit allocator 130, a first harmonic coding module 140, a first detector 150, a second harmonic coding module 160, a second detector 170, and a code excited linear prediction (CELP) module 180.

The pitch analyzer 110 analyzes the pitch of an input audio signal and detects a pitch lag tₚ. The pitch lag tₚ is obtained using a normalized auto-correlation function shown in Equation 1

$$R ( i ) = \frac{{\sum }_{n = 0}^{{L}_{I} - 1} s ( n ) s ( n - i )}{\sqrt{{\sum }_{n = 0}^{{L}_{I} - 1} {s}^{2} ( n - i )}} , i = {L}_{MIN} , … , {L}_{MAX} , \qquad ( 1 )$$

where s(n) is the input audio signal, L_{f} is the length of a portion of the audio signal s(n) to be analyzed, and L_{MIN} and L_{MAX} are the maximum and minimum of the pitch, respectively. In general, L_{MIN} and L_{MAX} are 20 and 143, respectively. Maximum values of R(i) are found for L_{MIN}≮≮_{MIN}+19, L_{MIN}+20≮≮_{MIN}+39, L_{MIN}+40≮≮_{MAX}, respectively. If the respective values of i as t₃, t₂, and t₁, one value is selected from t₃, t₂, and t₁ as a pitch lag tₚ based on Equation 2.

```
          tₚ=t₁
        R(tₚ) = R(t₁)
      if R(t₂) = 0.85 R(tₚ)
          R(tₚ) = R(t₂)
            tₚ = t₂
          End
      if R(t₃) = 0.85R(tₚ)
          R(tₚ) = R(t₃)
            tₚ = t₃
end  (2)
```

The pitch lag tₚ detected by the pitch analyzer 110 is provided to the first harmonic coding module 140.

The signal classifier 120 determines whether harmonics are included in the input audio signal. That is, the signal classifier 120 detects values of the input signal such as a sharpness rate, a right and left energy rate, a zero-crossing rate, and a first-order prediction coefficient, compares a threshold value for each detected value with the detected values, and if the comparison result satisfies a predetermined condition, the signal classifier 120 can determine that the harmonics are included in the input audio signal. The comparison can be performed in subframe units. The determination result of the signal classifier 120 is provided to the bit allocator 130.

The bit allocator 130 provides allocation bit information for the first harmonic coding module 140, the second harmonic coding module 150, and the CELP module 180 according to the determined result provided by the signal classifier 120. If a signal indicating that the harmonics are included in the input audio signal is provided by the signal classifier 120, the bit allocator 130 can provide information indicating that bits are allocated at a ratio of 3:3:2, for example, to the first harmonic coding module 140, the second harmonic coding module 150, and the CELP module 180. If a signal indicating that the harmonics are not included in the input audio signal is provided by the signal classifier 120, the bit allocator 130 can provide information indicating that bits are allocated at a ratio of 2:2:4, for example, to the first harmonic coding module 140, the second harmonic coding module 150, and the CELP module 180. The bit allocation information can be set in advance.

The first harmonic coding module 140 performs harmonic coding on the input audio signal using the pitch lag and outputs a linear prediction coding (LPC) coefficient quantized for audio decoding, a quantized LPC (QLPC) coefficient index, and a quantized phase index.

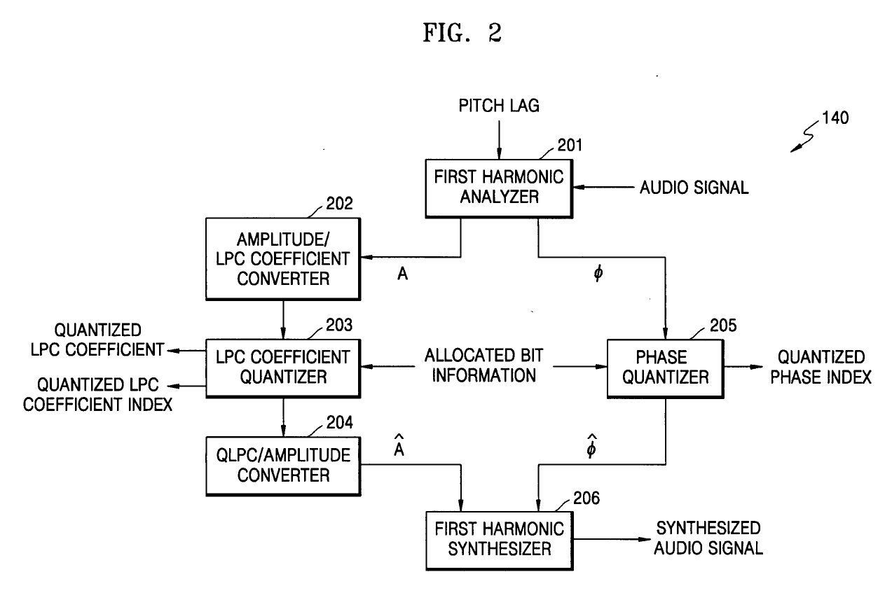

To this end, the first harmonic coding module 140 includes a first harmonic analyzer 201, an amplitude/LPC coefficient converter 202, an LPC coefficient quantizer 203, a QLPC/amplitude converter 204, a phase quantizer 205, and a first harmonic synthesizer 206, as shown in FIG. 2.

The first harmonic analyzer 201 analyzes harmonics of the input audio signal using a pitch lag (or a pitch delay). That is, the first harmonic analyzer 201 searches for a fundamental frequency ω₀ using the pitch lag and searches for harmonic parameters using a sine dictionary. The harmonic parameters include an amplitude A and a phase φ.

The amplitude A and the phase φ of the sine dictionary are found using a matching pursuit (MP) algorithm in which the input audio signal s(n) is used as a target signal. The input audio signal S_{H}(n) can be expressed using the sine dictionary as shown in Equation 3

$${s}_{H} ( n ) = {w}_{ham} ( n ) {\sum }_{k = 0}^{K - 1} {A}_{k} cos ( {ω}_{k} n + {ϕ}_{k} ) , \qquad ( 3 )$$

where Aₖ is the amplitude of a k-th sine wave, ωₖ is an angle frequency of the k-th sine wave, φₖ is the phase of the k-th sine wave, wₕₐₘ(n) is a hamming window, and K is the number of sine dictionaries, which is generally obtained using Equation 4.

$$K = ⌊ \frac{{t}_{p}}{2} ⌋ \qquad ( 4 )$$

The angle frequency ωₖ of sine dictionaries can be obtained using Equation 5.

$${ω}_{k} = \frac{2 π}{{t}_{p}} ( k + 1 ) \qquad ( 5 )$$

Referring to FIGS. 1 and 2, the search for the amplitude A and the phase φ of the sine dictionary using the MP algorithm is performed in such a way that an operation of projecting a k-th target signal on a k-th sine dictionary to extract the amplitude of a component and an operation of offsetting the extracted amplitude of the component with the k-th target signal to generate a new (k+1)-th target signal are repeatedly performed. The amplitude and the phase of the sine dictionary using the MP algorithm can be found using Equation 6

$${E}_{k} = {\sum }_{n = 0}^{{L}_{sf} - 1} {{w}_{ham} ( n ) [ {r}_{h , k} ( n ) - {A}_{k} cos ( {ω}_{k} n + {ϕ}_{k} ) ]}^{2} , \qquad ( 6 )$$

where r_{h,k} is a k-th target signal and Eₖ is a value obtained by multiplying a mean squared error between r_{h,k} and a k-th sine dictionary by a hamming window wham. If k=0, r_{h,k}(n) is the same as the original audio signal s(n). Aₖ and φₖ which minimize Eₖ can be defined using Equation 7.

$${A}_{k} = \sqrt{{a}_{k}^{2} + {b}_{k}^{2}} , {ϕ}_{k} = - {tan}^{- 1} ( \frac{{b}_{k}}{{a}_{k}} ) \\ {a}_{k} = \frac{\begin{matrix}{\sum }_{n = 0}^{{L}_{sf} - 1} {sin}^{2} ( {ω}_{k} n ) {\sum }_{n = 0}^{ {L}_{ sf} - 1} {r}_{h , k} ( n ) cos ( {ω}_{k} n ) - \\ {\sum }_{n = 0}^{{L}_{sf} - 1} cos ( {ω}_{k} n ) sin ( {ω}_{k} n ) {\sum }_{n = 0}^{ {L}_{ sf} - 1} {r}_{h , k} ( n ) sin ( {ω}_{k} n )\end{matrix}}{\begin{matrix}{\sum }_{n = 0}^{{L}_{sf} - 1} {cos}^{2} ( {ω}_{k} n ) {\sum }_{n = 0}^{{L}_{sf} - 1} {sin}^{2} ( {ω}_{k} n ) - \\ {\sum }_{n = 0}^{{L}_{sf} - 1} cos ( {ω}_{k} n ) sin ( {ω}_{k} n ) {\sum }_{n = 0}^{{L}_{sf} - 1} cos ( {ω}_{k} n ) sin ( {ω}_{k} n )\end{matrix}} , \\ {b}_{k} = \frac{\begin{matrix}{\sum }_{n = 0}^{{L}_{sf} - 1} {cos}^{2} ( {ω}_{k} n ) {\sum }_{n = 0}^{ {L}_{ sf} - 1} {r}_{h , k} ( n ) sin ( {ω}_{k} n ) - \\ {\sum }_{n = 0}^{{L}_{sf} - 1} cos ( {ω}_{k} n ) sin ( {ω}_{k} n ) {\sum }_{n = 0}^{ {L}_{ sf} - 1} {r}_{h , k} ( n ) cos ( {ω}_{k} n )\end{matrix}}{\begin{matrix}{\sum }_{n = 0}^{{L}_{sf} - 1} {cos}^{2} ( {ω}_{k} n ) {\sum }_{n = 0}^{{L}_{sf} - 1} {sin}^{2} ( {ω}_{k} n ) - \\ {\sum }_{n = 0}^{{L}_{sf} - 1} cos ( {ω}_{k} n ) sin ( {ω}_{k} n ) {\sum }_{n = 0}^{{L}_{sf} - 1} cos ( {ω}_{k} n ) sin ( {ω}_{k} n )\end{matrix}} \qquad ( 7 )$$

The first harmonic analyzer 201 transmits the amplitude of the sine dictionary to the amplitude/LPC coefficient converter 202 and transmits the phase of the sine dictionary to the phase quantizer 205.

The amplitude/LPC coefficient converter 202 converts the amplitude A of the input sine dictionary into an LPC coefficient. The LPC coefficient analyzer 203 quantizes the LPC coefficient using the allocated bit information provided by the bit allocator 130 and outputs the quantized LPC (QLPC) coefficient and the quantized LPC coefficient index.

The QLPC/amplitude converter 204 converts the quantized LPC coefficient into an amplitude vector Â of the quantized sine dictionary and outputs the amplitude vector Â.

The phase quantizer 205 quantizes a phase output from the first harmonic analyzer 201 based on the allocated bit information provided by the bit allocator 130 and outputs a quantized phase vector \hat{φ} and a quantized phase index.

The first harmonic synthesizer 206 synthesizes the amplitude vector Â of the quantized sine dictionary output from the QLPC/amplitude converter 204 and the quantized phase vector \hat{φ} output from the phase quantizer 205 using Equation 8 to obtain a synthesized audio signal \hat{S_{H}}(n) with respect to the input audio signal.

$${\hat{s}}_{H} ( n ) = {w}_{ham} {\sum }_{k = 0}^{K} {\hat{A}}_{k} cos ( {ω}_{k} n + {\hat{ϕ}}_{k} ) \qquad ( 8 )$$

The first harmonic synthesizer 206 transmits the synthesized audio signal \hat{s_{H}}(n) to the first detector 150.

The first detector 150 detects and outputs a first difference audio signal obtained from the first difference between the input audio signal and the synthesized audio signal output from the first harmonic coding module 140.

The second harmonic coding module 160 harmonically codes the first difference audio signal detected by the first detector 150 using the quantized LPC coefficient obtained by the first harmonic coding module 140 and a previous output signal of the second harmonic coding module 160, outputs a first synthesized difference audio signal, a harmonic index quantized for audio signal decoding and a first quantized gain index.

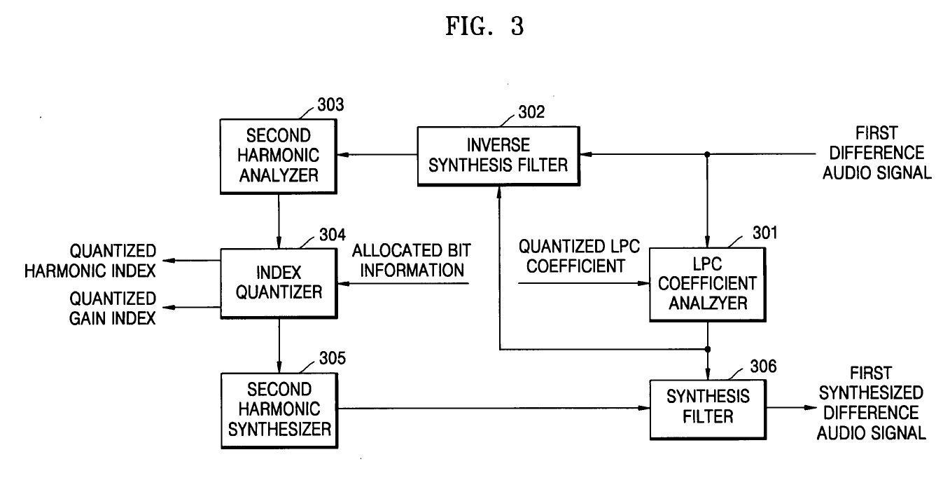

To this end, referring to FIG. 3, the second harmonic coding module 160 includes an LPC coefficient analyzer 301, an inverse synthesis filter 302, a second harmonic analyzer 303, an index quantizer 304, a second harmonic synthesizer 305, and a synthesis filter 306.

The LPC coefficient analyzer 301 analyzes an LPC coefficient on the first difference audio signal output from the first detector 150 using the quantized LPC coefficient provided by the first harmonic coding module 140 and extracts an LPC coefficient needed by the second harmonic coding module 160.

The LPC coefficient analyzer 301 can be configured to extract a reduced LPC coefficient when the order of the quantized LPC coefficient provided by the first harmonic coding module 140 must be reduced according to the operation conditions of a corresponding audio coding apparatus. An LPC coefficient can be reduced by obtaining only necessary LPC coefficients in a head part among transmitted LPC coefficients. In this case, the number of LPC coefficients should be even. For example, when the order of the quantized LPC coefficient is P and the order of an LPC coefficient to be intended to be used in the second harmonic coding module 160 is Q, the number of Q LPC coefficients existed in the head part are extracted from all P LPC coefficients. The extracted LPC coefficients are provided to the inverse synthesis filter 302 and the synthesis filter 306, respectively.

The inverse synthesis filter 302 performs the inverse operation of the operation performed by a synthesis filter on the first difference audio signal detected by the first detector 150 to generate an excitation signal of the first difference audio signal and transmits the generated excitation signal to the second harmonic analyzer 303.

Referring to FIGS. 1-3, the second harmonic analyzer 303 has the same structure as the first harmonic analyzer 201 of FIG. 2, searches for an amplitude A and a phase φ of the sine dictionary with respect to the excitation signal output from the inverse synthesis filter 302 and outputs a harmonic index including the amplitude A and the phase φ of the sine dictionary. The output harmonic index is transmitted to the index quantizer 304.

The index quantizer 304 quantizes the harmonic index output from the second harmonic analyzer 303 using the allocated bit information provided by the bit allocator 130 and outputs the quantized harmonic index and the quantized gain index.

The second harmonic synthesizer 305 has the same structure as the first harmonic synthesizer 206 of FIG. 2, synthesizes the quantized harmonic index output from the index quantizer 304, and outputs the synthesized audio signal.

The synthesis filter 306 outputs the first synthesized difference audio signal by synthesis filtering the synthesized audio signal output from the second harmonic synthesizer 305 using the quantized LPC coefficient output from the LPC coefficient analyzer 301. The first synthesized difference audio signal is output to the second detector 170.

The second detector 170 detects a difference audio signal obtained from the difference between the first difference audio signal output from the first detector 150 and the first synthesized difference audio signal output from the second harmonic coding module 160 and outputs the detected difference audio signal as a second difference audio signal.

The CELP module 180 CELP-codes the second difference audio signal output from the second detector 170 using the quantized LPC coefficient obtained by the first harmonic coding module 140 and outputs a stochastic index quantized and a second quantized gain index in order to decode an audio signal.

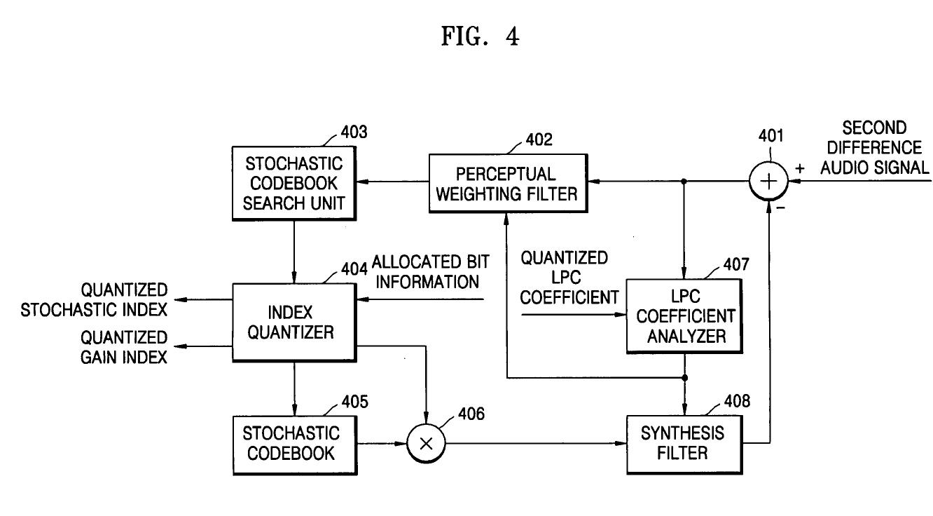

To this end, the CELP module 180 includes a third detector 401, a perceptual weighting filter 402, a stochastic codebook search unit 403, an index quantizer 404, a stochastic codebook 405, a multiplier 406, an LPC coefficient analyzer 407, and a synthesis filter 408, as shown in FIG. 4.

The third detector 401 detects a difference audio signal obtained from a difference between the second difference audio signal output from the second detector 170 and a synthesized audio signal previously obtained by the CELP module 180.

The perceptual weighting filter 402 perceptual-weighting-filters the difference audio signal using the LPC coefficient provided by the LPC coefficient analyzer 407 so that quantization noise of the difference audio signal output from the third detector 401 is equal to or less than a masking level using a hearing masking effect.

The stochastic codebook search unit 403 searches one corresponding stochastic codebook based on a signal output from the perceptual weighting filter 402 and outputs an index of the searched stochastic codebook.

The index quantizer 404 quantizes the index provided by the stochastic codebook search unit 403 and outputs the quantized stochastic codebook index and the quantized gain index.

The stochastic codebook 405 includes a plurality of stochastic codebooks and outputs a stochastic codebook that corresponds to the quantized stochastic codebook index provided by the index quantizer 404.

The multiplier 406 multiplies the stochastic codebook output from the stochastic codebook 405 by the quantized gain output from the index quantizer 404.

The LPC coefficient analyzer 407 analyzes the quantized LPC coefficient of the signal output from the third detector 401 using the quantized LPC coefficient provided by the first harmonic coding module 140 and extracts the quantized LPC coefficient. The method of extracting the quantized LPC coefficient is similar to the method used in the LPC coefficient analyzer 301 provided in the second harmonic coding module 160.

The extracted LPC coefficient is provided to the perceptual weighting filter 402 and the synthesis filter 408.

The synthesis filter 408 performs synthesis filtering on the signal output from the multiplier 406 using the quantized LPC coefficient output from the LPC coefficient analyzer 407 and provides the synthesis-filtered result to the third detector 401. The synthesis filtering is performed by obtaining an impulse response of the synthesis filter 408 from the quantized LPC coefficient and then convoluting the impulse response and the signal output from the multiplier 406 to obtain the synthesized audio signal.

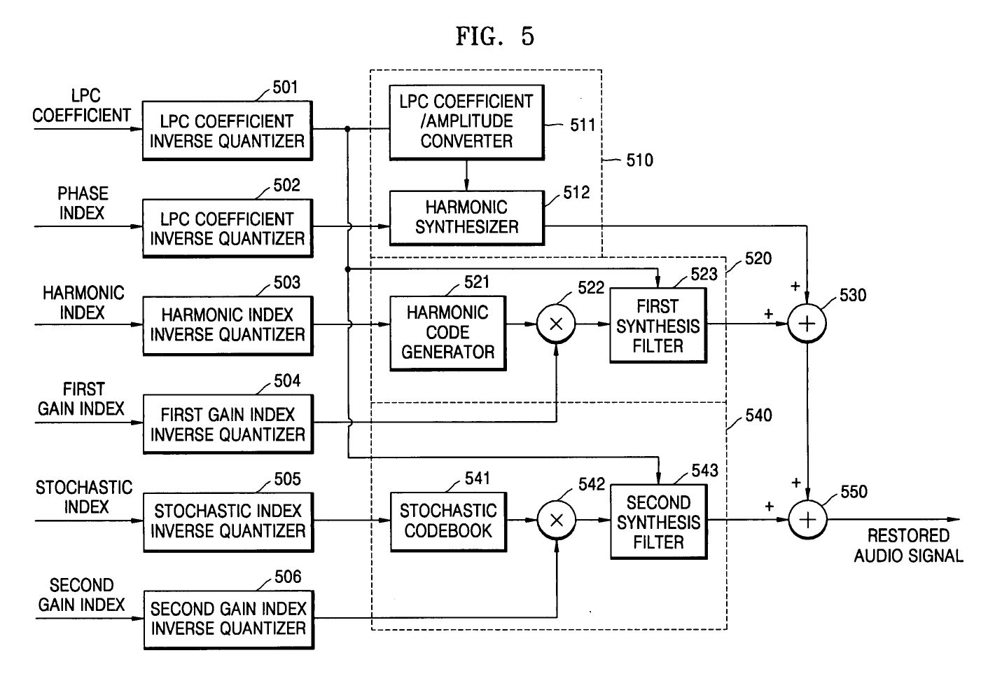

FIG. 5 is a functional block diagram of an audio decoding apparatus according to another embodiment of the present invention. Referring to FIG. 5, the audio decoding apparatus of FIG. 5 includes an LPC coefficient inverse quantizer 501, a phase index inverse quantizer 502, a harmonic index inverse quantizer 503, a first gain index inverse quantizer 504, a stochastic index quantizer 505, a second gain index inverse quantizer 506, a first harmonic decoding module 510, a second harmonic decoding module 520, a first adder 530, a CELP decoding module 540, and a second adder 550.

The inverse quantizers 501, 502, 503, 504, 505, and 506 can constitute an inverse quantization unit for inversely quantizing a plurality of parameters for restoring an audio signal.

The first harmonic coding module 510 performs harmonic decoding using an LPC coefficient output from the LPC coefficient inverse quantizer 501 and a phase vector output from the phase index inverse quantizer 502 to output the restored audio signal including harmonics.

To this end, the first harmonic coding module 510 includes an LPC coefficient/amplitude converter 511 and a harmonic synthesizer 512.

The LPC coefficient/amplitude converter 511 converts the LPC coefficient into a amplitude vector Â of a sine dictionary. The harmonic synthesizer 512 synthesizes the phase vector \hat{φ} output from the phase index inverse quantizer 502 with the amplitude vector Â of the sine dictionary output from the LPC/amplitude converter 511 using Equation 8 and outputs an audio signal including harmonics. The output audio signal including harmonics is output to the first adder 530.

The second harmonic coding module 520 performs harmonic coding based on the LPC coefficient output from the LPC coefficient inverse quantizer 501, a harmonic index output from the harmonic index inverse quantizer 503, and a first gain value output from the first gain index inverse quantizer 504.

To this end, the second harmonic coding module 520 includes a harmonic code generator 521, a first multiplier 522, and a first synthesis filter 523.

The harmonic code generator 521 includes a plurality of harmonic codes and generates a harmonic code based on the input harmonic index. The first multiplier 522 multiplies the generated harmonic code by the first gain value.

The first synthesis filter 523 performs synthesis filtering on the signal output from the first multiplier 522 based on the input LPC coefficient and outputs the synthesized and filtered audio signal to the first adder 530. If the audio signal output from the first multiplier 522 is sₕ(n), the LPC coefficient is a and the synthesized and filtered audio signal is s₁(n), the synthesis filtering can be defined by Equation 9

$${s}_{1} ( n ) = {s}_{h} ( n ) - {\sum }_{i = 1}^{p} {a}_{i} {s}_{1} ( n - i ) , \qquad ( 9 )$$

where p is the order of the LPC coefficient.

The first adder 530 adds the signal output from the first harmonic coding module 510 to the signal output from the second harmonic coding module 520 and outputs the added result to the second adder 550.

The CELP decoding unit 540 performs CELP decoding based on the stochastic index output from the stochastic index inverse quantizer 505 and the second gain value output from the second gain index inverse quantizer 506.

To this end, the CELP decoding module 540 includes a stochastic codebook 541, a multiplier 542, and a second synthesis filter 543.

The stochastic codebook 541 includes a plurality of stochastic codebooks and outputs a stochastic codebook corresponding to the stochastic index.

The second multiplier 542 multiplies the second gain value by the stochastic codebook. The second synthesis filter 543 provides the synthesized audio signal obtained by performing synthesis filtering on the signal output from the second multiplier 542 based on the LPC coefficient using Equation 9 to the second adder 550.

The second adder 550 adds the signal output from the first adder 530 to the signal output from the CELP decoding module 540 to restore the audio signal and outputs the restored audio signal.

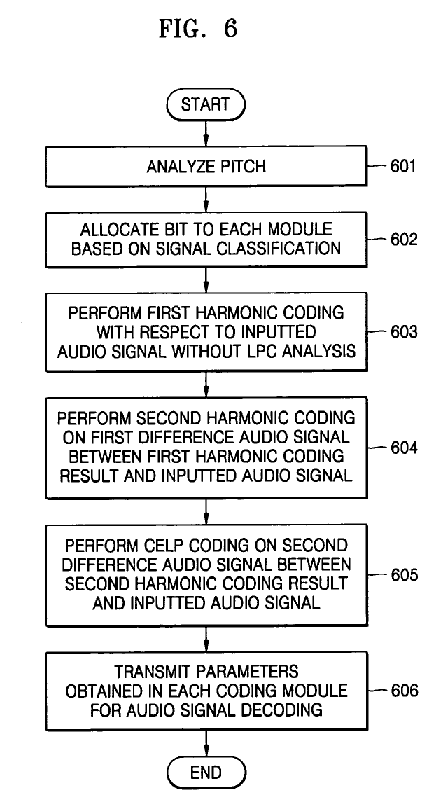

FIG. 6 is a flowchart illustrating an audio coding method according to another embodiment of the present invention. The audio coding method illustrated in FIG. 6 will now be described with reference to FIG. 1 for ease of explanation only.

In operation 601, a pitch of an input audio signal is analyzed to obtain a pitch lag.

In operation 602, it is determined whether harmonics are included in the input audio signal to classify the input audio signal and bits allocated to the first harmonic coding module 140, the second harmonic coding module 160, and the CELP module 180 based on the classification.

In operation 603, harmonic coding is performed with respect to the input audio signal by the first harmonic coding module 140 using the pitch lag obtained in operation 601, without analyzing an LPC coefficient. That is, harmonic analysis with respect to the input audio signal is performed, the amplitude of the sine dictionary detected by harmonic analysis is converted into an LPC coefficient, the LPC coefficient is quantized and converted into the amplitude vector, and harmonic synthesis is performed. The quantized LPC coefficient is used in second harmonic coding and CELP coding.

In operation 604, a difference audio signal obtained as a difference between the input audio signal and the harmonic coding result obtained in operation 603 is set as a first difference audio signal, an LPC coefficient of the first difference audio signal is analyzed, and harmonic coding is performed on the first difference audio signal by the second harmonic coding module 160. Here, the LPC coefficient of the first difference audio signal is extracted using the quantized LPC coefficient detected in operation 603.

In operation 605, a difference audio signal obtained as a difference between the harmonic coding result obtained from the first difference audio signal and the input audio signal is set as a second difference audio signal, and the second difference audio signal is CELP coded by the CELP module 180. In the CELP coding, the LPC coefficient of the second difference audio signal is extracted using the quantized LPC coefficient detected in operation 603.

In operation 606, the plurality of parameters obtained in operations 603, 604, and 605 are transmitted in order to decode an audio signal. The plurality of parameters include the quantized LPC coefficient index, a quantized phase index, a quantized harmonic index, a first quantized gain index, a quantized stochastic index, and a second quantized gain index.

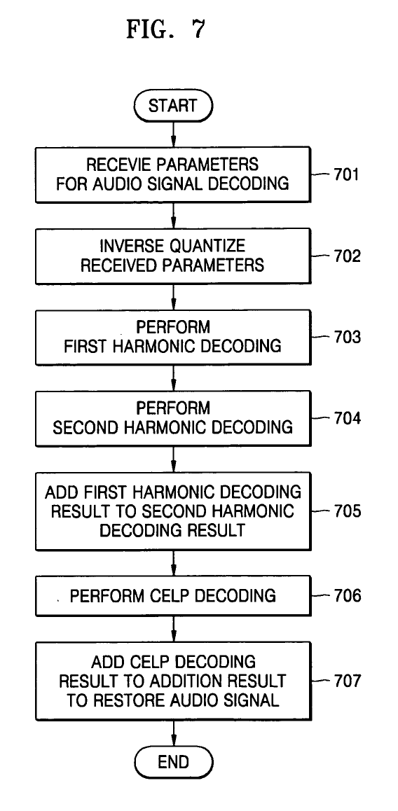

FIG. 7 is a flowchart illustrating an audio decoding method according to another embodiment of the present invention. The audio decoding method illustrated in FIG. 7 will now be described with reference to FIG. 5 for ease of explanation only.

A plurality of parameters for restoring an audio signal are received in operation 701, and each of the plurality of received parameters is inverse quantized in operation 702.

In operation 703, harmonic decoding is performed by the first harmonic coding module 510 based on an LPC coefficient and a phase value obtained in operation 702. In operation 704, harmonic decoding is performed by the second harmonic coding module 520 based on the LPC coefficient, a harmonic index, and a first gain value obtained in operation 702. In operation 705, an audio signal in which the first harmonic decoding result obtained in operation 703 is added to the second harmonic decoding result obtained in operation 704 is obtained. In operation 706, CELP decoding is performed by the CELP decoding module 540 based on a stochastic index and a second gain value obtained in operation 702.

In operation 707, the addition result obtained in operation 705 is added to the CELP decoding result obtained in operation 706 to restore the audio signal.

Embodiments of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

According to the above-described embodiments of the present invention, harmonic analysis is performed twice such that more harmonics can be searched for using the same bits.

Allocation of bits used in harmonic coding is variably performed according to whether harmonics are included in the input audio signal such that a coarse granularity scalability function can be easily supported and harmonic sound quality can be optimised.

In addition, after harmonic coding in which the LPC coefficient is not analysed is performed, harmonic coding in which the LPC coefficient is analysed is performed, and then, CELP coding is performed such that pitch halving prediction or pitch doubling prediction can be prevented and lowering of sound quality can be minimized.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An audio coding apparatus comprising:
a first harmonic coding module performing first harmonic coding on an input audio signal using a pitch lag of the input audio signal and producing a quantized linear prediction coding coefficient;
a first detector detecting a first difference audio signal from a difference between an audio signal output from the first harmonic coding module and the input audio signal;
a second harmonic coding module performing harmonic coding on the first difference audio signal using the quantized linear prediction coding coefficient and a previous harmonic coding result;
a second detector detecting a second difference audio signal obtained from a difference between an audio signal output from the second harmonic coding module and the first difference audio signal; and
a code excited linear prediction (CELP) module CELP coding the second difference audio signal using the quantized linear prediction coding coefficient obtained from the first harmonic coding module.

2. The audio coding apparatus of claim 1, wherein the first harmonic coding module converts an amplitude of harmonics of the input audio signal into a linear prediction coding coefficient, quantizes the converted linear prediction coding coefficient, and provides the quantized linear prediction coding coefficient to the second harmonic coding module and to the CELP module, respectively.

3. The audio coding apparatus of claim 2, wherein the second harmonic coding module extracts a quantized linear prediction coding coefficient for the second harmonic coding using the quantized linear prediction coding coefficient obtained from the first harmonic coding module.

4. The audio coding apparatus of claim 3, wherein the CELP module extracts a quantized linear prediction coding coefficient for the CELP coding using the quantized linear prediction coding coefficient obtained from the first harmonic coding module.

5. The audio coding apparatus of claim 1, wherein the CELP module extracts a quantized linear prediction coding coefficient for the CELP coding using the quantized linear prediction coding coefficient obtained from the first harmonic coding module.

6. The audio coding apparatus of claim 2, further comprising a bit allocator allocating bit information for the first harmonic coding module, the second harmonic coding module, and the CELP module according to whether the input audio signal includes harmonics.

7. The audio coding apparatus of claim 6, wherein, when the input audio signal include harmonics, the bit allocator allocates the least bit to the CELP module, and when the input audio signal does not include harmonics, the bit allocator allocates the most bit to the CELP module.

8. The audio coding apparatus of claim 2, wherein the first harmonic coding module comprises:
a first harmonic analyzer analyzing harmonics of the input audio signal using the pitch lag;
a first converter converting the amplitude of the audio signal output from the first harmonic analyzer into a linear prediction coding coefficient;
a linear prediction coding coefficient quantizer quantizing the linear prediction coding coefficient using the allocated bit information provided by the bit allocator and outputting the quantized linear prediction coding coefficient and a quantized linear prediction coefficient index;
a second converter converting the quantized linear prediction coding coefficient into an amplitude and outputting the quantized amplitude value;
a phase quantizer quantizing a phase output from the first harmonic analyzer based on the allocated bit information provided by the bit allocator and outputting a quantized phase and a quantized phase index; and
a first harmonic synthesizer synthesizing the quantized phase with the quantized amplitude output from the second converter and outputting a synthesized audio signal corresponding to the input audio signal.

9. The audio coding apparatus of claim 8, wherein the second harmonic coding module comprises:
a linear prediction coding coefficient analyzer obtaining a quantized linear prediction coding coefficient of the first difference audio signal using the quantized linear prediction coding coefficient obtained from the first harmonic coding module;
an inverse synthesis filter outputting an excitation signal of the first difference audio signal by performing inverse synthesis filtering on the first difference audio signal using the linear prediction coding coefficient provided by the linear prediction coding coefficient analyzer;
a second harmonic analyzer analyzing harmonics of the excitation signal and generating a harmonic index;
an index quantizer quantizing the harmonic index output from the second harmonic analyzer;
a second harmonic synthesizer performing harmonic synthesis based on the quantized harmonic index output from the index quantizer to generate a harmonic-synthesized signal; and
a synthesis filter performing synthesis filtering on the harmonic-synthesized signal output from the second harmonic synthesizer based on the linear prediction coding coefficient output from the linear prediction coding coefficient analyzer and outputting a synthesized audio signal corresponding to the first difference audio signal.

10. The audio coding apparatus of claim 9, wherein the CELP module comprises:
a third detector detecting a difference audio signal obtained from a difference between the second difference audio signal and a synthesized audio signal previously obtained by the CELP module;
a linear prediction coding coefficient analyzer extracting a linear prediction coding coefficient of the difference audio signal output from the third detector using the quantized linear prediction coding coefficient provided by the first harmonic coding module;
a perceptual weighting filter performing perceptual weighting filtering on the difference audio signal output from the third detector using the linear prediction coding coefficient provided by the linear prediction coding coefficient analyzer;
a stochastic codebook search unit searching a stochastic codebook based on a signal output from the perceptual weighting filter;
an index quantizer quantizing an index provided by the stochastic codebook search unit and outputting a quantized stochastic codebook index and a quantized gain index;
a stochastic codebook outputting a stochastic codebook corresponding to the quantized stochastic codebook index provided by the index quantizer;
a multiplier multiplying a quantized gain output from the index quantizer by the stochastic codebook output from the stochastic codebook; and
a synthesis filter synthesis filtering a signal output from the multiplier using the linear prediction coding coefficient output from the linear prediction coding coefficient analyzer, obtaining a synthesized audio signal on the second difference audio signal, and providing the synthesized audio signal to the third detector.

11. The audio coding apparatus of claim 2, wherein the second harmonic coding module comprises:
a linear prediction coding coefficient analyzer obtaining a quantized linear prediction coding coefficient on the first difference audio signal using the quantized linear prediction coding coefficient obtained from the first harmonic coding module;
an inverse synthesis filter outputting an excitation signal of the first difference audio signal by performing inverse synthesis filtering on the first difference audio signal using the linear prediction coding coefficient provided by the linear prediction coding coefficient synthesizer;
a second harmonic analyzer analyzing harmonics of the excitation signal and generating a harmonic signal;
an index quantizer quantizing the harmonic index output from the second harmonic analyzer;
a second harmonic synthesizer performing harmonic synthesis based on the quantized harmonic index output from the index quantizer to generated a harmonic-synthesized signal; and
a synthesis filter performing synthesis filtering on the harmonic-synthesized signal output from the second harmonic synthesizer based on the linear prediction coding coefficient output from the linear prediction coding coefficient analyzer and outputting a synthesized audio signal corresponding to the first difference audio signal.

12. The audio coding apparatus of claim 6, further comprising:
a pitch analyzer analyzing a pitch of the input audio signal and outputting the pitch lag; and
a signal classifier determining whether harmonics are included in the input audio signal and providing the determination result to the bit allocator.

13. The audio coding apparatus of claim 7, further comprising:
a pitch analyzer analyzing a pitch of the input audio signal and outputting the pitch lag; and
a signal classifier determining whether harmonics are included in the input audio signal and providing the determination result to the bit allocator.

14. An audio decoding apparatus comprising:
an inverse quantization unit inverse quantizing each of a plurality of parameters to restore an audio signal;
a first harmonic decoding module performing harmonic decoding using a linear prediction coding coefficient and a phase vector output from the inverse quantization unit;
a second harmonic decoding module performing harmonic decoding based on the linear prediction coding coefficient, a harmonic index, and a first gain value output from the inverse quantization unit;
a first adder adding a signal output from the first harmonic decoding module to a signal output from the second harmonic decoding module;
a code excited linear prediction (CELP) decoding module performing CELP decoding based on a stochastic codebook index output from the inverse quantization unit and a second gain value output from the inverse quantization unit; and
a second adder adding a signal output from the first adder to a signal output from the CELP decoding module and outputting the result as a restored audio signal.

15. The audio decoding apparatus of claim 14, wherein the first harmonic decoding module comprises:
a converter converting the linear prediction coding coefficient into an amplitude; and
a harmonic synthesizer synthesizing the phase vector with the amplitude output from the converter and outputting an audio signal including harmonics to the first adder.

16. The audio decoding apparatus of claim 15, wherein the second harmonic decoding module comprises:
a harmonic code generator generating a harmonic code based on the harmonic index;
a first multiplier multiplying the harmonic code by the first gain value; and
a first synthesis filter providing to the first adder a synthesized audio signal obtained by performing synthesis filtering on a signal output from the first multiplier based on the linear prediction coding coefficient.

17. The audio decoding apparatus of claim 16, wherein the CELP decoding module comprises:
a stochastic codebook outputting a stochastic codebook based on the stochastic index;
a second multiplier multiplying the second gain value by the stochastic codebook; and
a second synthesis filter providing to the second adder a synthesized audio signal obtained by performing synthesis filtering on a signal output from the second multiplier based on the linear prediction coding coefficient.

18. The audio decoding apparatus of claim 15, wherein the CELP decoding module comprises:
a stochastic codebook outputting a stochastic codebook based on the stochastic index;
a second multiplier multiplying the second gain value by the stochastic codebook; and
a second synthesis filter providing to the second adder a synthesized audio signal obtained by performing synthesis filtering on a signal output from the second multiplier based on the linear prediction coding coefficient.

19. An audio coding method comprising:
harmonically coding an input audio signal without analyzing a linear prediction coding coefficient;
analyzing a linear prediction coding coefficient of a difference audio signal obtained from a difference between the input audio signal and the harmonic-coding result and harmonically coding the difference audio signal; and
CELP coding a difference audio signal obtained from a difference between the result of harmonically coding on the difference audio signal and the input audio signal.

20. The method of claim 19, wherein the harmonic coding comprises:
converting the amplitude of harmonics of the input audio signal into a linear prediction coding coefficient; and
quantizing the linear prediction coding coefficient, and
wherein the harmonic coding of the difference audio signal and the CELP coding include extracting a linear prediction coding coefficient needed in each of the coding process using the quantized linear prediction coding coefficient.

21. The method of claim 20, further comprising determining whether harmonics are included in the input audio signal and allocating bits for the coding.

22. The method of claim 20, further comprising analyzing a pitch of the input audio signal and obtaining a pitch lag, wherein the harmonic coding without analyzing the linear prediction coding coefficient includes performing harmonic analysis on the input audio signal using the pitch lag.

23. An audio decoding method comprising:
inverse quantizing a plurality of parameters for restoring an audio signal;
first harmonic decoding using a linear prediction coding coefficient and a phase vector obtained through the inverse quantizing;
second harmonic decoding using a linear prediction coding coefficient, a harmonic index, and a first gain value obtained through the inverse quantizing;
first adding the first harmonic decoding result to the second harmonic decoding result;
CELP decoding using a stochastic index and a second gain value obtained through the inverse quantization; and
adding the result obtained through the first adding to the result obtained through the CELP decoding to obtain a restored audio signal.

24. A recording medium on which a program for performing an audio coding method is recorded, the audio coding method comprising:
harmonically coding an input audio signal without analyzing a linear prediction coding coefficient;
analyzing a linear prediction coding coefficient of a difference audio signal obtained from a difference between the input audio signal and the harmonic-coding result and harmonically coding the difference audio signal; and
CELP coding a difference audio signal obtained from a difference between the result of harmonically coding on the difference audio signal and the input audio signal.

25. A recording medium on which a program for performing an audio decoding method is performed, the audio decoding method comprising:
inverse quantizing a plurality of parameters for restoring an audio signal;
first harmonic decoding using a linear prediction coding coefficient and a phase vector obtained through the inverse quantizing;
second harmonic decoding using a linear prediction coding coefficient, a harmonic index, and a first gain value obtained through the inverse quantizing;
first adding the first harmonic decoding result to the second harmonic decoding result;
CELP decoding using a stochastic index and a second gain value obtained through the inverse quantization; and
second adding the result obtained through the first adding to the result obtained through the CELP decoding to obtain a restored audio signal.
